(19) United States
(12) Patent Application Publication
(10) Pub. No.: US 2022/0372911 A1
(43) Pub. Date: Nov. 24, 2022

(54) REAR-MOUNT TURBOCHARGER INTAKE SYSTEM

(71) Applicant: Robby Gordon, Charlotte, NC (US)

(72) Inventor: Robby Gordon, Charlotte, NC (US)

(21) Appl. No.: 17/746,167

(22) Filed: May 17, 2022

Related U.S. Application Data
(60) Provisional application No. 63/189,865, filed on May 18, 2021.

(51) Int. Cl. F02C 7/05; F02C 6/12; F02C 7/14

(52) U.S. Cl. CPC F02C 7/05; F02C 6/12; F02C 7/14; F05D 2220/40; F05D 2260/211; F05D 2260/213; F05D 2260/607; F05D 2260/96

(57) ABSTRACT

An apparatus and methods are provided for a turbocharger intake system for an off-road vehicle. The turbocharger intake system comprises a turbocharger disposed at a rear of an engine of the vehicle, such that heat radiated from the turbocharger is directed rearward of the engine during operation of the vehicle. The turbocharger is coupled with an exhaust manifold for conducting exhaust gases from the engine to the turbocharger. An air intake duct is routed from an intake air filter canister to the turbocharger for conveying filtered air to the turbocharger. A suitable air filter is housed within the intake air filter canister so as to remove airborne particulate matter from the air entering the engine. The turbocharger drives charged intake air through an intercooler for lowering the temperature of charged intake air. The charged intake air is directed to combustion chambers of the engine by way of an intake manifold.

### PRIORITY

This application claims the benefit of and priority to U.S. Provisional application, entitled “Rear-Mount Turbocharger Intake System,” filed on May 18, 2021, and having application Ser. No. 63/189,865, the entirety of said application being incorporated herein by reference.

### FIELD

Embodiments of the present disclosure generally relate to engine air/fuel intake systems. More specifically, embodiments of the disclosure relate to an apparatus and methods for a rear-mount turbocharger intake system for an off-road vehicle.

### BACKGROUND

Off-road vehicles enjoy an enthusiastic following because of their many uses and versatility. As a result, several types of motorsports involve racing of various types of off-road vehicles. For example, competitions exist that are dedicated to various types of terrain, such as rally, desert racing, and rock-crawling. Besides their use in various motorsports, off-road vehicles commonly are used for sight-seeing and traveling to areas that may not be accessed by way of standard, paved roads.

Many off-road vehicles include turbocharged engines. A turbocharger generally is a turbine-driven, forced induction device configured to increase the efficiency and power output of an engine. As compared to a naturally aspirated engine, a turbocharged engine produces greater output power because the turbine forces more air, and proportionately more fuel, into the engine's combustion chambers than atmospheric pressure alone. The greater output power of turbocharged engines is particularly popular for use in off-road racing vehicles. A drawback, however, is that hot exhaust gases that drive the turbocharger may radiate unwanted heat into a passenger cabin of the vehicle as well as contribute to increased engine temperatures. As such, there is a desire to optimize the implementation of a turbocharger on an engine without giving rise to unwanted heating of nearby components and the passenger cabin of the vehicle.

### SUMMARY

An apparatus and methods are provided for a turbocharger intake system for an off-road vehicle. The turbocharger intake system comprises a turbocharger disposed at a rear of an engine of the vehicle, such that heat radiated from the turbocharger is directed rearward of the engine during operation of the vehicle. The turbocharger is coupled with an exhaust manifold for conducting exhaust gases from the engine to the turbocharger. An air intake duct is routed from an intake air filter canister to the turbocharger for conveying filtered air to the turbocharger. A suitable air filter is housed within the intake air filter canister so as to remove airborne particulate matter from the air entering the engine. The turbocharger drives charged intake air through an intercooler for lowering the temperature of charged intake air. The charged intake air is directed to combustion chambers of the engine by way of an intake manifold.

In an exemplary embodiment, a turbocharger intake system for an off-road vehicle comprises: a turbocharger disposed at a rear of an engine of the vehicle; an exhaust manifold for conducting exhaust gases from the engine to the turbocharger; a turbine comprising the turbocharger that is set in rotation by the exhaust gases; an air intake duct for conveying filtered air to the turbocharger; an intercooler for lowering the temperature of charged intake air from the turbocharger; and an intake manifold for directing the charged intake air into combustion chambers of the engine.

In another exemplary embodiment, the turbocharger is disposed at a rear of the engine so as to direct radiant heat rearward of the engine during operation of the vehicle. In another exemplary embodiment, the exhaust gases exiting the turbocharger enter an exhaust muffler by way of an exhaust duct. In another exemplary embodiment, the exhaust muffler causes the exhaust gases to follow a reciprocating path through one or more chambers and/or around one or more baffles before exiting the muffler by way of an exhaust duct. In another exemplary embodiment, the exhaust muffler is disposed at the rear of the engine so as to direct radiant heat rearward of the engine during operation of the vehicle.

In another exemplary embodiment, the turbocharger includes a turbine that forces relatively more air and fuel into the combustion chambers of the engine so as to cause the engine to generate more output power. In another exemplary embodiment, atmospheric air is drawn into the engine through an air inlet and then through an intake air filter canister. In another exemplary embodiment, a suitable air filter is housed within the intake air filter canister so as to remove airborne particulate matter from the air entering the engine. In another exemplary embodiment, the air intake duct is configured to direct filtered air exiting the intake air filter canister to the turbocharger. In another exemplary embodiment, the air intake duct comprises any combination of one or more straight tube portions and one or more curved or bent tube portions to convey the filtered air to the turbocharger disposed at the rear of the engine.

In another exemplary embodiment, the turbocharger drives charged intake air into a first driven air intake duct that directs the charged intake air to an intercooler. In another exemplary embodiment, the first driven air intake duct includes any combination of one or more straight tube portions and one or more curved or bent tube portions to direct the charged intake air from the turbocharger to the intercooler. In another exemplary embodiment, a second driven air intake duct directs charged intake air exiting the intercooler to the intake manifold of the engine. In another exemplary embodiment, the second driven air intake duct includes any combination of one or more straight tube portions and one or more curved or bent tube portions to convey the charged intake air from the intercooler to the intake manifold.

In an exemplary embodiment, a method for a turbocharger intake system for an off-road vehicle comprises: disposing a turbocharger at a rear of an engine of the vehicle; extending an exhaust manifold rearward of the engine; coupling the turbocharger with the exhaust manifold for conducting exhaust gases from the engine to the turbocharger; routing an air intake duct from an intake air filter canister to the turbocharger; extending a first driven air intake duct from the turbocharger to an intercooler; extending a second driven air intake duct from the intercooler to an intake manifold; and placing the intake manifold into communication with combustion chambers of the engine.

In another exemplary embodiment, disposing includes causing heat radiated from the turbocharger to directed rearward of the engine during operation of the vehicle. In another exemplary embodiment, disposing includes causing the exhaust gases exiting the turbocharger to enter an exhaust muffler by way of an exhaust duct. In another exemplary embodiment, disposing includes positioning the exhaust muffler at the rear of the engine so as to direct radiant heat rearward of the engine during operation of the vehicle.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an exemplary embodiment of an off-road vehicle that is configured to seat up to four occupants and is suitable for implementation of a rear-mount turbocharger intake system in accordance with the present disclosure;

FIG. 2 illustrates a top view of a rear portion of an exemplary embodiment of an off-road vehicle that includes a rear-mount turbocharger intake system according to the present disclosure; and

FIG. 3 illustrates an isometric view of an exemplary embodiment of an off-road vehicle engine that includes a rear-mount turbocharger intake system in accordance with the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the rear-mount turbocharger intake system and methods disclosed herein may be practiced without these specific details. In other instances, specific numeric references such as “first duct,” may be made. However, the specific numeric reference should not be interpreted as a literal sequential order but rather interpreted that the “first duct” is different than a “second duct.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Many off-road vehicles include turbocharged engines. The greater output power of turbocharged engines is particularly popular for use in off-road racing vehicles. A drawback, however, is that hot exhaust gases that drive the turbocharger have been observed to radiate unwanted heat into a passenger cabin of the vehicle as well as contribute to increased engine temperatures. As such, there is a desire to optimize the implementation of a turbocharger on an engine without giving rise to unwanted heating of nearby components and the passenger cabin of the vehicle. Embodiments disclosed herein provide an apparatus and methods for a rear-mount turbocharger intake system for an off-road vehicle.

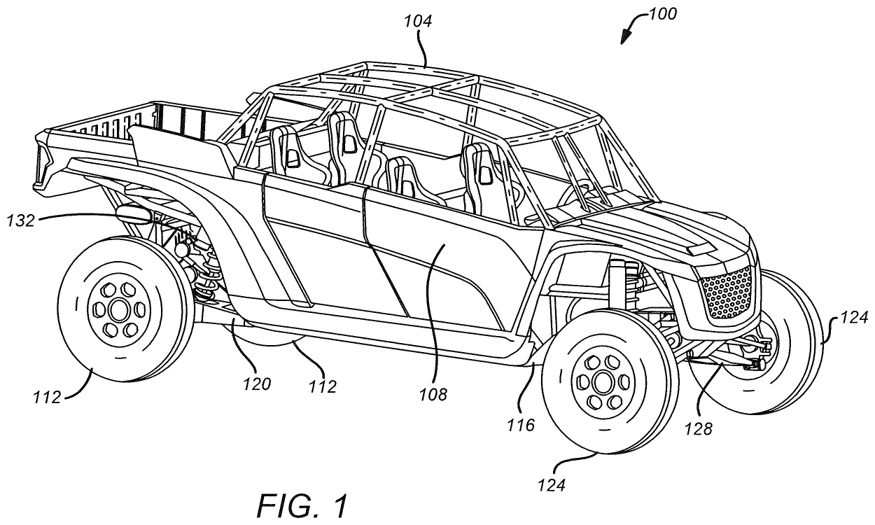

FIG. 1 shows an off-road vehicle 100 that is particularly suitable for implementation of a rear-mount turbocharger intake system in accordance with the present disclosure. The off-road vehicle 100 generally is of a Utility Task Vehicle (UTV) variety that seats up to four occupants, includes a roll-over protection system 104, and may have a cab enclosure 108. Rear wheels 112 of the off-road vehicle 100 may be operably coupled with a chassis 116 by way of a trailing arm suspension system 120. Front wheels 124 may be operably coupled with the chassis 116 by way of a front suspension system 128. In the illustrated embodiment of FIG. 1, the off-road vehicle 100 includes an internal combustion engine 132 that is mounted in a rear portion of the chassis 116. The engine 132 may include a rear-mounted turbocharger intake system that is configured to direct radiant heat away from nearby components, as described herein. It should be understood, however, that the rear-mount turbocharger intake system disclosed herein is not to be limited to the specific off-road vehicle 100 shown in FIG. 1, but rather the rear-mount turbocharger intake system may be incorporated into a wide variety of vehicles, other than the off-road vehicle 100 of FIG. 1, without limitation.

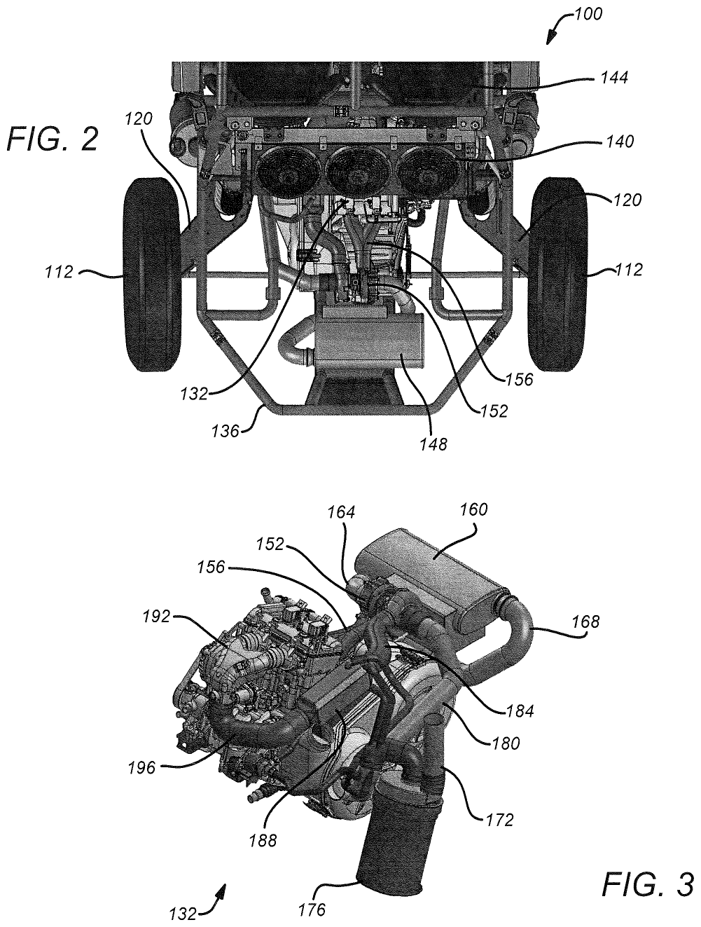

FIG. 2 illustrates a top view of a rear portion 136 of an exemplary embodiment of an off-road vehicle 100 that includes a rear-mount turbocharger intake system according to the present disclosure. The engine 132 is mounted within the rear portion 136 and operably coupled with the rear wheels 112. The rear wheels 112 are coupled with the chassis by way of the trailing arm suspension system 120, as mentioned hereinabove. In the illustrated embodiment of FIG. 2, the engine 132 is oriented within the rear portion 136 such that an engine cooling system 140 is disposed forward of the engine 132, near a passenger cabin portion 144 of the off-road vehicle 100. The engine cooling system 140 generally includes a radiator and one or more fans configured to remove heat from a cooling fluid that circulates between the radiator and the engine 132. As will be appreciated, positioning the engine cooling system 140 forward of the engine 132 serves to provide relatively cool air to the engine cooling system 140 during forward movement of the vehicle 100.

Moreover, the engine 132 includes an exhaust system 148, a turbocharger 152, and an exhaust manifold 156 that are disposed at a rearmost location of the engine 132. The rearmost disposition of the exhaust system 148 and the turbocharger 152 advantageously causes radiant heat to exit rearward of the vehicle 100 during operation. The turbocharger 152 includes a turbine that is driven by exhaust gases moving rearward within the exhaust manifold 156 to force relatively more air and fuel into the combustion chambers of the engine 132. Heat transferred to the turbocharger 152 by the exhaust gases advantageously is directed rearward of the engine 132, and thus away from the passenger cabin portion 144, during operation of the off-road vehicle 100.

FIG. 3 illustrates an isometric view of an exemplary embodiment of an off-road vehicle engine 132 that includes a turbocharger 152 in accordance with the present disclosure. As mentioned above, the turbocharger 152 generally is driven by exhaust gases moving rearward within the exhaust manifold 156 to force relatively more air and fuel into the combustion chambers of the engine 132. The exhaust manifold 156 is coupled with the engine 132 and extends rearward to the turbocharger 152. The exhaust gases traveling rearward within the exhaust manifold 156 turn a turbine comprising the turbocharger 152 before entering an exhaust muffler 160 by way of an exhaust duct 164. The exhaust muffler 160 may cause the exhaust gases to follow a reciprocating path through one or more chambers and around one or more baffles before exiting the muffler 160 by way of an exhaust duct 168. As mentioned hereinabove, the turbocharger 152, as well as the exhaust system 148 are disposed at a rear of the engine 132 so as to direct radiant heat rearward of the engine 132 during operation of the vehicle 100.

As will be recognized by those skilled in the art, the turbocharger 152 includes a turbine that forces relatively more air and fuel into the combustion chambers of the engine 132 so as to cause the engine 132 to generate more output power. In the illustrated embodiment, atmospheric air is drawn into the engine 132 through an air inlet 172 and then through an intake air filter canister 176. A suitable air filter preferably is housed within the canister 176 so as to remove airborne particulate matter from the air entering the engine 132. Filtered air exiting the canister 176 is then directed to the turbocharger 152 by way of an air intake duct 180. The air intake duct 180 may comprise any combination of one or more straight tube portions and one or more curved or bent tube portions as required to convey the filtered air to the turbocharger 152 disposed at the rear of the engine 132.

Intake air entering the turbocharger 152 by way of the air intake duct 180 is driven, under pressure, into a first driven air intake duct 184. The first driven air intake duct 184 directs charged intake air to an intercooler 188. The intercooler 188 generally is configured to cool the charged intake air before it enters the engine 132. As will be appreciated, decreasing the temperature of the charged intake air increases the power output of the combustion process within the engine 132. Charged intake air exiting the intercooler 188 is directed to an intake manifold 192 of the engine 132 by way of a second driven air intake duct 196. As will be appreciated, the intake manifold 192 directs the charged intake air and fuel into the combustion chambers of the engine 132. Further, it should be understood that the first and second driven air intake ducts 184, 196 may include any combination of one or more straight tube portions and one or more curved or bent tube portions as needed to convey the charged intake air from the turbocharger 152 to the intercooler 188 and from the intercooler 188 to the intake manifold 192 of the engine 132.

While the rear-mount turbocharger intake system and methods have been described in terms of particular variations and illustrative figures, those of ordinary skill in the art will recognize that the rear-mount turbocharger intake system is not limited to the variations or figures described. In addition, where methods and steps described above indicate certain events occurring in certain order, those of ordinary skill in the art will recognize that the ordering of certain steps may be modified and that such modifications are in accordance with the variations of the rear-mount turbocharger intake system. Additionally, certain of the steps may be performed concurrently in a parallel process, when possible, as well as performed sequentially as described above. To the extent there are variations of the rear-mount turbocharger intake system, which are within the spirit of the disclosure or equivalent to the rear-mount turbocharger intake system found in the claims, it is the intent that this patent will cover those variations as well. Therefore, the present disclosure is to be understood as not limited by the specific embodiments described herein, but only by scope of the appended claims.

What is claimed is:

1. A turbocharger intake system for an off-road vehicle, the system comprising:
a turbocharger disposed at a rear of an engine of the vehicle;
an exhaust manifold for conducting exhaust gases from the engine to the turbocharger;
a turbine comprising the turbocharger that is set in rotation by the exhaust gases;
an air intake duct for conveying filtered air to the turbocharger;
an intercooler for lowering the temperature of charged intake air from the turbocharger; and
an intake manifold for directing the charged intake air into combustion chambers of the engine.

2. The system of claim 1, wherein the turbocharger is disposed at a rear of the engine so as to direct radiant heat rearward of the engine during operation of the vehicle.

3. The system of claim 1, wherein the exhaust gases exiting the turbocharger enter an exhaust muffler by way of an exhaust duct.

4. The system of claim 3, wherein the exhaust muffler causes the exhaust gases to follow a reciprocating path through one or more chambers and/or around one or more baffles before exiting the muffler by way of an exhaust duct.

5. The system of claim 4, wherein the exhaust muffler is disposed at the rear of the engine so as to direct radiant heat rearward of the engine during operation of the vehicle.

6. The system of claim 1, wherein the turbocharger includes a turbine that forces relatively more air and fuel into the combustion chambers of the engine so as to cause the engine to generate more output power.

7. The system of claim 1, wherein atmospheric air is drawn into the engine through an air inlet and then through an intake air filter canister.

8. The system of claim 7, wherein a suitable air filter is housed within the intake air filter canister so as to remove airborne particulate matter from the air entering the engine.

9. The system of claim 8, wherein the air intake duct is configured to direct filtered air exiting the intake air filter canister to the turbocharger.

10. The system of claim 9, wherein the air intake duct comprises any combination of one or more straight tube portions and one or more curved or bent tube portions to convey the filtered air to the turbocharger disposed at the rear of the engine.

11. The system of claim 1, wherein the turbocharger drives charged intake air into a first driven air intake duct that directs the charged intake air to an intercooler.

12. The system of claim 11, wherein the first driven air intake duct includes any combination of one or more straight tube portions and one or more curved or bent tube portions to direct the charged intake air from the turbocharger to the intercooler.

13. The system of claim 11, wherein a second driven air intake duct directs charged intake air exiting the intercooler to the intake manifold of the engine.

14. The system of claim 13, wherein the second driven air intake duct includes any combination of one or more straight tube portions and one or more curved or bent tube portions to convey the charged intake air from the intercooler to the intake manifold.

15. A method for a turbocharger intake system for an off-road vehicle, comprising:
disposing a turbocharger at a rear of an engine of the vehicle;
extending an exhaust manifold rearward of the engine;
coupling the turbocharger with the exhaust manifold for conducting exhaust gases from the engine to the turbocharger;
routing an air intake duct from an intake air filter canister to the turbocharger;
extending a first driven air intake duct from the turbocharger to an intercooler;
extending a second driven air intake duct from the intercooler to an intake manifold; and
placing the intake manifold into communication with combustion chambers of the engine.

16. The method of claim 15, wherein disposing includes causing heat radiated from the turbocharger to be directed rearward of the engine during operation of the vehicle.

17. The method of claim 15, wherein disposing includes causing the exhaust gases exiting the turbocharger to enter an exhaust muffler by way of an exhaust duct.

18. The method of claim 18, wherein disposing includes positioning the exhaust muffler at the rear of the engine so as to direct radiant heat rearward of the engine during operation of the vehicle.
